(19) United States
(12) Patent Application Publication
(10) Pub. No.: US 2010/0233550 A1
(43) Pub. Date: Sep. 16, 2010

(54) NON-AQUEOUS ELECTROLYTE SECONDARY BATTERY

(75) Inventors: Katsunori Yanagida, Kobe-shi (JP); Denis Yau Wai Yu, Kobe-shi (JP); Koh Masahara, Kobe-shi (JP); Daizo Jito, Kobe-shi (JP); Maruo Kamino, Kobe-shi (JP); Takeshi Ogasawara, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/724,770

(22) Filed: Mar. 16, 2010

(30) Foreign Application Priority Data
Mar. 16, 2009 (JP) 2009-063095
Jul. 10, 2009 (JP) 2009-0163363
Aug. 25, 2009 (JP) 2009-0193903

(51) Int. Cl. H01M 6/16

(52) U.S. Cl. 429/338

(57) ABSTRACT

A non-aqueous electrolyte secondary battery has a positive electrode containing a positive electrode active material, a negative electrode, and a non-aqueous electrolyte solution in which an electrolyte is dissolved in a non-aqueous solvent. The positive electrode active material includes a lithium-containing transition metal oxide that releases oxygen during initial charge, and the non-aqueous solvent contains a fluorinated cyclic carbonate in which fluorine atoms are directly bonded to a carbonate ring.

### BACKGROUND OF THE INVENTION

1. Field of the Invention

The present invention relates to a non-aqueous electrolyte secondary battery that contains a lithium-containing transition metal oxide as a positive electrode active material.

2. Description of Related Art

Significant size and weight reductions in mobile electronic devices have been achieved in recent years. In addition, the power consumption of such devices has been increasing as the number of functions of the devices has increased. As a consequence, demand has been increasing for lighter weight and higher capacity non-aqueous electrolyte secondary batteries used as the power sources for such devices.

In order to increase the capacity of the non-aqueous electrolyte secondary battery, it is necessary to use a positive electrode active material having a high energy density. To date, lithium-containing layered oxides such as LiCoO₂, LiNiO₂, and LiNi_{1/3}Mn_{1/3}Co_{1/3}O₂ have been studied. However, when more than half of the lithium is extracted from LiCoO₂ (when x≧0.6 in Li₁₋ₓCoO₂) in the case of using LiCoO₂ as the positive electrode active material, the crystal structure degrades, and the reversibility deteriorates. Thus, with LiCoO₂, the usable discharge capacity density is about 160 mAh/g, and it is difficult to achieve a higher energy density. Likewise, LiNiO₂ and LiNi_{1/3}Mn_{1/3}Co_{1/3}O₂ also have the same problem.

Under such circumstances, lithium-excess transition metal oxides such as represented by Li₂MnO₃ (Li[Li_{1/3}Mn_{2/3}]O₂) and its solid solutions have drawn attention as high energy density positive electrode materials. They have a layered structure like LiCoO₂ and contain lithium in the transition metal layer in addition to the lithium layer, so they have a large amount of lithium that is involved in charge-discharge reactions. See, for example, U.S. Pat. Nos. 6,677,082 (Patent Document 1), 6,680,143 (Patent Document 2), 7,368,071 (Patent Document 3), and C. S. Johnson et al., Electrochemistry Communications, 6, 1085-1091 (2004) (Non-patent Document 1).

The lithium-excess transition metal oxides are represented by the general formula Li[LiₓMn_{y}M_{z}]O₂ (where x+y+z=1 and M is at least one metal element selected from the transition metals). They yield varied working voltages and capacities depending on the type of the metal element M. For this reason, the battery voltage can be freely set by selecting the element M. Moreover, they show relatively high theoretical capacities ranging from about 300 mAh/g to about 460 mAh/g, so it is possible to obtain a large battery capacity per unit mass. Furthermore, since manganese is used as a main component, the amounts of rare metals, such as cobalt and nickel, can be reduced. Thus, the lithium-excess transition metal oxides have the advantages that the manufacturing costs can be significantly reduced while maintaining high energy density.

However, in order to make use of the high capacity of the lithium-excess transition metal oxides, a charge potential of 4.5 V or higher versus metallic lithium is necessary, and in order to ensure sufficient cycle performance, it has been a problem to inhibit the oxidative decomposition of the electrolyte solution at high voltage.

Moreover, it is known that the lithium-excess transition metal oxides undergo an irreversible structural change during the initial charge. This structural change is believed to originate from the Li₂MnO₃ (i.e., Li[Li_{1/3}Mn_{2/3}]O₂) component, and is believed to be due to oxygen desorption from the transition metal oxide that is associated with Li desorption. (See R. Armstrong et al., J. Am. Chem. Soc., 128, 8694-8698 (2006) (Non-patent Document 2), which is herein incorporated by reference).

As a means to improve the cycle performance of a non-aqueous electrolyte secondary battery at high voltage, it has been proposed to use, as the non-aqueous solvent, a fluorinated cyclic carbonate in which fluorine atoms are directly bonded to a carbonate ring. However, there has been no specific illustration as to a combination of the fluorinated cyclic carbonate with a lithium-containing transition metal oxide that releases oxygen during the initial charge, and there has been no study about the influence of the oxygen desorption from the positive electrode active material on battery performance. See, for example, Japanese Published Unexamined Patent Application Nos. 2007-250415 (Patent Document 4) and 2006-332020 (Patent Document 5).

### BRIEF SUMMARY OF THE INVENTION

It is an object of the present invention to provide a non-aqueous electrolyte secondary battery containing a lithium-containing transition metal oxide that releases oxygen during the initial charge as a positive electrode active material, the non-aqueous electrolyte secondary battery having a high discharge capacity and excellent cycle performance at high voltage.

The present invention provides a non-aqueous electrolyte secondary battery comprising: a positive electrode containing a positive electrode active material, a negative electrode, and a non-aqueous electrolyte solution in which an electrolyte is dissolved in a non-aqueous solvent, wherein: the positive electrode active material comprises a lithium-containing transition metal oxide that releases oxygen during initial charge; and the non-aqueous solvent contains a fluorinated cyclic carbonate in which fluorine atoms are directly bonded to a carbonate ring.

The present invention makes available a non-aqueous electrolyte secondary battery having a high discharge capacity and good cycle performance at high voltage.

Examples of the lithium-containing transition metal oxide that releases oxygen during initial charge include a lithium-containing transition metal oxide in which a transition metal of transition metal sites is substituted by lithium. A specific example is a lithium-containing transition metal oxide represented by the general formula Li₁₊ₐMn_{b}Ni_{c}Co_{d}Oₑ, where 0<a<0.4, 0.4<b<1, 0≦c<0.4, 0≦d<0.4, 1.9<e<2.1, and a+b+c+d=1.

In more detail, examples of the lithium-containing transition metal oxide that releases oxygen during initial charge include lithium-excess transition metal oxides such as represented by Li₂MnO₃ (i.e., Li[Li_{1/3}Mn_{2/3}]O₂) and its solid solution. Examples include one represented by the general formula Li[LiₓMn_{y}M_{z}]O₂ where 0<x≦⅓, 0<y<1, 0≦z<1, x+y+z=1 and M is at least one metal element selected from the transition metals.

It is preferable that the lithium-containing transition metal oxide that releases oxygen during initial charge have a structure belonging to the space group C2/m or C2/c. Examples thereof include a lithium-containing transition metal oxide having a mixed phase of a structure belonging to the space group R-3m and a structure belonging to the space group C2/m or C2/c.

A particularly preferable example of the fluorinated cyclic carbonate used in the present invention is 4-fluoroethylene carbonate.

It is preferable that the potential of the positive electrode be 4.5 V or higher versus metallic lithium in a fully charged state as a battery. In addition, it is preferable that the lithium-containing transition metal oxide used in the present invention release oxygen during initial charge in a charge-discharge cycle in which the potential of the positive electrode is 4.5 V or higher versus metallic lithium in a fully charged state as a battery.

The present invention can enhance the discharge capacity of a non-aqueous electrolyte secondary battery and obtain a non-aqueous electrolyte secondary battery having good cycle performance at high voltage.

### BRIEF DESCRIPTION OF THE DRAWINGS

FIG. 1 is a schematic cross-sectional view illustrating a three-electrode beaker cell (test cell) prepared in the examples according to the present invention.

### DETAILED DESCRIPTION OF THE INVENTION

Hereinbelow, examples of a positive electrode, a non-aqueous electrolyte solution, and a negative electrode that constitute the non-aqueous electrolyte secondary battery according to the present invention will be described in detail. It should be construed, however, that the present invention is not limited to the following examples. Various changes and modifications are possible without departing from the scope of the invention.

### Positive Electrode

The positive electrode in the present invention contains a lithium-containing transition metal oxide that releases oxygen during initial charge as the positive electrode active material. As mentioned above, it is preferable that the lithium-containing transition metal oxide release oxygen during initial charge in the case where the potential of the positive electrode is 4.5 V or higher versus metallic lithium in a fully charged state as a battery.

Examples of the lithium-containing transition metal oxide that releases oxygen during initial charge include lithium-excess transition metal oxides such as represented by Li₂MnO₃ (i.e., Li[Li_{1/3}Mn_{2/3}]O₂) and its solid solution. Examples include one represented by the general formula Li[LiₓMn_{y}M_{z}]O₂ where 0<x≦⅓, 0<y<1, 0≦z<1, x+y+z=1, and M is at least one metal element selected from the transition metals. It is known that this lithium-excess transition metal oxide shows oxygen desorption and an irreversible structural change during the initial charge (see Non-patent Document 2).

The positive electrode used in the present invention contains, as the positive electrode active material, a lithium-containing transition metal oxide represented by the general formula xLi[Li_{1/3}Mn_{2/3}]O₂.(1−x)LiMO₂ where 0<x≦1 and M is at least one transition metal element selected from the group consisting of Ni, Co, and Mn. A preferable range of x is x=0.4-0.7 because a high discharge capacity is obtained when x is in the just-mentioned range.

A lithium-containing transition metal oxide represented by the general formula Li₁₊ₐMn_{b}Ni_{c}Co_{d}Oₑ (where 0<a<0.4, 0.4<b<1, 0≦c<0.4, 0≦d<0.4, 1.9<e<2.1, and a+b+c+d=1) is especially preferable because it shows a high discharge capacity. A lithium-containing transition metal oxide represented by the general formula Li₁₊ₐMn_{b}Ni_{c}Co_{d}Oₑ (where 0.1<a<0.4, 0.4<b<1, 0<c<0.2, 0<d<0.2, 1.9<e<2.1, and a+b+c+d=1) is still more preferable since shows an even higher discharge capacity.

A solid solution of Li₂MnO₃ (i.e., Li[Li_{1/3}Mn_{2/3}]O₂) and LiNi_{1/3}Co_{1/3}Mn_{1/3}O₂ is preferable in order to achieve both a high discharge capacity and high discharge rate performance, and it may be represented as xLi[Li_{1/3}Mn_{2/3}]O₂.(1−x)LiNi_{1/3}Co_{1/3}Mn_{1/3}O₂. A preferable range of x is x=0.4-0.7 because a high discharge capacity is obtained when x is in the just-mentioned range.

It is preferable that the lithium-containing transition metal oxide that releases oxygen during initial charge have a structure belonging to the space group C2/m or C2/c, since such a lithium-containing transition metal oxide shows a high capacity. Moreover, it is preferable that the lithium-containing transition metal oxide have a mixed phase of a structure belonging to the space group R-3m and a structure belonging to the space group C2/m or C2/c. By employing the mixed phase of the structure belonging to the space group R-3m and the structure belonging to the space group C2/m or C2/c, the crystal structure is stable even when charged to a high potential of 4.5 V or higher versus metallic lithium. As a result, a non-aqueous electrolyte battery having high capacity and excellent cycle performance is obtained.

When synthesizing the lithium-containing transition metal oxide that releases oxygen during initial charge, it is possible to use a common method that is used for synthesizing a transition metal oxide, such as a solid phase method. For example, the lithium-containing transition metal oxide may be synthesized by mixing a lithium salt, a manganese salt, a cobalt salt, and a nickel salt at a predetermined mole ratio and sintering the mixture at 700° C. to 900° C.

For these lithium-containing transition metal oxides, it is preferable that the surface of the lithium-containing transition metal oxide be coated with microparticles of an inorganic compound such as Al₂O₃. Moreover, it is preferable that an Al-containing oxide and/or Al-containing hydroxide having protruding-shape is adhered to or coated on the surface of the lithium-containing transition metal oxide in such a manner as to be dispersed uniformly. With such a configuration, the decomposition of the non-aqueous electrolyte solution in a high charge voltage state is inhibited, and the high-voltage cycle performance is improved further.

If the amount of the Al-containing oxide and/or Al-containing hydroxide having protruding-shape is too small, the just-described effects may not be obtained sufficiently. Therefore, it is preferable that the amount of the Al-containing oxide and/or Al-containing hydroxide having protruding-shape adhered be 0.05 mass % or greater, more preferably 0.1 mass % or greater, with respect to the total amount of the positive electrode active material. On the other hand, if the amount of the Al-containing oxide and/or Al-containing hydroxide having protruding-shape is too large, the relative amount of the positive electrode active material becomes smaller, so the battery capacity obtained may be too low. Therefore, it is preferable that the amount of the Al-containing oxide and/or Al-containing hydroxide having protruding-shape adhered be 5 mass % or less, more preferably 3 mass % or less, with respect to the amount of the positive electrode active material.

If the proportion of the Al-containing hydroxide is large in the Al-containing oxide and/or Al-containing hydroxide having protruding-shape adhered to the surface of the positive electrode active material particles, the Al-containing hydroxide may react with the non-aqueous electrolyte solution during the charge-discharge cycles, resulting in gas formation. For this reason, it is preferable that the proportion of the Al-containing oxide having protruding-shape adhered to the positive electrode active material surface be larger, and more preferably, only Al-containing oxide having protruding-shape be adhered thereto.

A preferable method for causing the Al-containing oxide and/or Al-containing hydroxide having protruding-shape adhere to the surface of the positive electrode active material particles in such a manner as to be dispersed uniformly includes a step of depositing an Al-containing hydroxide onto the surface of the positive electrode active material particles in an aqueous solution in which an Al salt is dissolved, and a step of heat-treating the positive electrode active material on which the Al-containing hydroxide is deposited.

When depositing the Al-containing hydroxide onto the surface of the positive electrode active material particles in an aqueous solution in which an Al salt is dissolved, the pH of the aqueous solution containing the Al salt be adjusted within the range of from 7 to 11. If the pH of the aqueous solution containing the Al salt is less than 7, the aqueous solution may partially react with the lithium in the foregoing positive electrode active material. On the other hand, if the pH exceeds 11, the foregoing Al-containing hydroxide may be dissolved and may not be deposited on the surface of the positive electrode active material particles.

In particular, when depositing the Al-containing hydroxide on the surface of the positive electrode active material particles, it is preferable that the pH of the aqueous solution in which the Al salt is dissolved be within the range of from 7 to 10, more preferably from 7 to 9, in order to deposit further smaller Al-containing hydroxide uniformly over the surface of the positive electrode active material particles.

In the method of causing the Al-containing oxide and/or Al-containing hydroxide having protruding-shape adhere to the surface of the positive electrode active material particles in such a manner as to be dispersed uniformly, it is preferable that the temperature of the heat treatment be 200° C. or higher when heat-treating the positive electrode active material on which the Al-containing hydroxide is deposited. If the temperature of the heat treatment is low, the Al-containing hydroxide deposited on the surface of the positive electrode active material particles may not change into an Al-containing oxide, and as described above, the Al-containing hydroxide on the surface of the positive electrode active material particles may react with the non-aqueous electrolyte solution, resulting in gas formation.

These positive electrode active materials are mixed with a conductive agent, such as acetylene black or carbon black, and a binder agent, such as polytetrafluoroethylene (PTFE) or polyvinylidene fluoride (PVdF), and used as a mixture.

When using the positive electrode for a non-aqueous electrolyte secondary battery, it is preferable that the potential of the positive electrode in a fully charged state as a battery be 4.5 V or higher versus metallic lithium. When the potential of the positive electrode is 4.7 V or higher in a fully charged state as a battery, an even higher capacity can be obtained. Although the upper limit is not particularly limited, it is preferable that the potential of the positive electrode in a fully charge state be 5.0 V or lower. The reason is that if the potential is too high, problems such as the decomposition of the electrolyte solution may arise.

In the present invention, the positive electrode may contain lithium phosphate (Li₃PO₄).

When lithium phosphate (Li₃PO₄) is contained in the positive electrode, a high discharge capacity can be obtained even at a high discharge rate. As a result, the discharge rate property can be improved.

It is preferable that the amount of the lithium phosphate (Li₃PO₄) contained in the positive electrode be within the range of from 0.5 mass % to 5 mass % with respect to the amount of the positive electrode active material contained in the positive electrode. In other words, it is preferable that the amount of the lithium phosphate be within the range of from 0.5 to 5 parts by mass per 100 parts by mass of the positive electrode active material. If the content of the lithium phosphate is too small, the effect of increasing the discharge rate ratio may not be obtained sufficiently. If the content of the lithium phosphate is too large, the relative content of the positive electrode active material decreases, so the discharge capacity may become low.

### Non-Aqueous Electrolyte Solution

The non-aqueous electrolyte solution used in the present invention contains, as a non-aqueous solvent, a fluorinated cyclic carbonate in which fluorine atoms are directly bonded to a carbonate ring.

Examples of the fluorinated cyclic carbonate in which fluorine atoms are directly bonded to a carbonate ring include ethylene carbonates in which the hydrogen atoms bonded to a carbonate ring are substituted by fluorine atoms, such as 4-fluoroethylene carbonate, 4,5-difluoro ethylene carbonate, 4,4-difluoro ethylene carbonate, 4,4,5-trifluoroethylene carbonate, and 4,4,5,5-tetrafluoroethylene carbonate.

Among them, 4-fluoroethylene carbonate has a relatively low viscosity and shows high capability of forming a protective surface film on the negative electrode. Moreover, 4-fluoroethylene carbonate is preferable because, when using the lithium-containing transition metal oxide that releases oxygen as the positive electrode active material, it effectively prevents the decomposition of the electrolyte solution that is induced by the oxygen radicals resulting from the oxygen released from the positive electrode.

It is preferable that the fluorinated cyclic carbonate be contained in an amount of to 50 volume %, more preferably 10 to 40 volume %, as a solvent of the non-aqueous electrolyte solution.

If the content of the fluorinated cyclic carbonate is too small, it may not be possible to obtain a non-aqueous electrolyte secondary battery having high capacity and good cycle performance at high voltage. On the other hand, if the content of the fluorinated cyclic carbonate is too large, the protective surface film formed on the negative electrode becomes too thick, degrading the battery performance.

Examples of the solvent of the non-aqueous electrolyte solution used in the present invention include cyclic carbonic esters, chain carbonic esters, esters, cyclic ethers, chain ethers, nitriles, amides, and combinations thereof, in addition to the fluorinated cyclic carbonate.

Examples of the cyclic carbonic esters include ethylene carbonate, propylene carbonate, and butylenes carbonate. It is also possible to use a cyclic carbonic ester in which part or all of the hydrogen groups of one of the foregoing cyclic carbonic esters is/are fluorinated. Examples include trifluoropropylene carbonate and fluoroethylene carbonate.

Examples of the chain carbonic esters include dimethyl carbonate, ethyl methyl carbonate, diethyl carbonate, methyl propyl carbonate, ethyl propyl carbonate, and methyl isopropyl carbonate. It is also possible to use a chain carbonic ester in which part or all of the hydrogen groups of one of the foregoing chain carbonic esters is/are fluorinated.

Examples of the esters include methyl acetate, ethyl acetate, propyl acetate, methyl propionate, ethyl propionate, and γ-butyrolactone.

Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ether.

Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butylphenyl ether, pentylphenyl ether, methoxytoluene, benzyl ethyl ether, diphenyl ether, dibenzyl ether, o-dimethoxybenzene, 1,2-diethoxyethane, 1,2-dibutoxy ethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile. Examples of the amides include dimethylformamide.

In the present invention, the non-aqueous solvent may be at least one of the foregoing examples.

The electrolyte that is added to the non-aqueous solvent may be any lithium salt that is commonly used in conventional non-aqueous electrolyte secondary batteries. LiPF₆, LiBF₄, LiAsF₆, LiClO₄, LiCF₃SO₃, LiN(FSO₂)₂, LiN(CₗF₂ₗ₊₁SO₂)(CₘF₂ₘ₊₁SO₂) (where 1 and m are an integer equal to or greater than 1), LiC(CₚF₂ₚ₊SO₂)(C_{q}F_{2q+1}SO₂)(C₂ᵣF₂ᵣ₊₁SO₂) (where p, q, and r are an integer equal to or greater than 1), Li[B(C₂O₄)₂] (lithium bis(oxalato) borate (LiBOB)), Li[B(C₂O₄)F₂], Li[P(C₂O₄)F₄], and Li[P(C₂O₄)₂F₂]. These lithium salts may be used either alone or in combination.

### Negative Electrode

It is preferable to use a material capable of intercalating and deintercalating lithium as the negative electrode active material. Examples include metallic lithium, lithium alloys, carbonaceous substances, and metallic compounds. These negative electrode active materials may be used either alone or in combination.

Examples of the lithium alloys include lithium-aluminum alloy, lithium-silicon alloy, lithium-tin alloy, and lithium-magnesium alloy.

Examples of the carbonaceous substances capable of intercalating and deintercalating lithium include natural graphite, artificial graphite, coke, vapor grown carbon fibers, mesophase pitch-based carbon fibers, spherical carbon, and resin-sintered carbon.

### Non-Aqueous Electrolyte Secondary Battery

In addition to the positive electrode active material, the negative electrode active material, and the non-aqueous electrolyte as described above, the non-aqueous electrolyte secondary battery according to the present invention may comprise other battery components, such as a separator, a battery case, and a current collector serving to retain active material and perform current collection. The components other than the positive electrode active material and the non-aqueous solvent are not particularly limited, and various known components may be selectively used.

### EXAMPLES

Hereinbelow, the present invention is described in further detail by way of examples thereof. It should be construed, however, that the present invention is not limited to the following examples but various changes and modifications are possible without departing from the scope of the invention.

### Experiment 1

### Example 1

### Preparation of Positive Electrode

In Example 1, a lithium-excess transition metal oxide Li_{1.2}Mn_{0.54}Ni_{0.13}Co_{0.13}O₂ was used as the positive electrode active material.

First, lithium hydroxide (LiOH) and Mn_{0.67}Ni_{0.17}Co_{0.17}(OH)₂ prepared by coprecipitatation were mixed so as to be in a desired stoichiometric ratio, and the mixed powder was used as the starting material. The mixed powder was formed into pellets and sintered in the air at 900° C. for 24 hours. Thus, a positive electrode active material comprising Li_{1.2}Mn_{0.54}Ni_{0.13}Co_{0.13}O₂ was synthesized.

The resultant lithium-containing transition metal oxide (Li_{1.2}Mn_{0.54}Ni_{0.13}Co_{0.13}O₂) was analyzed by powder X-ray diffraction analysis for phase identification. The phase identified was a mixed phase of a structure belonging to the space group R-3m and a structure belonging to the space group C2/m or C2/c.

Next, using the lithium-containing transition metal oxide as the positive electrode active material, 90 parts by mass of the active material, 5 parts by mass of acetylene black as a conductive agent, and 5 parts by mass of polyvinylidene fluoride as a binder agent were mixed together, and thereafter, N-methyl-2-pyrrolidone was added to the mixture to prepare a slurry. The resultant slurry was applied onto one side of a current collector made of an aluminum foil and then dried. Thereafter, the resultant material was pressed using pressure rollers and then cut into a predetermined size. Next, a current collector lead made of aluminum was attached to a portion of the electrode on which the slurry was not applied. A positive electrode was thus prepared.

### Preparation of Negative Electrode

A rolled lithium plate with a predetermined thickness was cut into a predetermined size, and a current collector lead made of nickel was attached thereto. Thus, a negative electrode was prepared.

### Preparation of Non-Aqueous Electrolyte Solution

Lithium hexafluorophosphate (LiPF₆) was dissolved at a concentration of 1 mole/liter in a non-aqueous solvent in which 4-fluoroethylene carbonate (FEC) and ethyl methyl carbonate (EMC) were mixed in a volume ratio of 3:7, whereby a non-aqueous electrolyte solution was prepared.

### Preparation of Battery

The positive electrode and the negative electrode prepared in the above-described manner were opposed with a polyethylene separator interposed therebetween, and they were placed in a laminate case. The laminate case was filled with the above-described non-aqueous electrolyte solution and then sealed. Thus, a non-aqueous electrolyte battery A1 was prepared.

### Comparative Example 1

A non-aqueous electrolyte solution was prepared by dissolving lithium hexafluorophosphate (LiPF₆) at a concentration of 1 mole/liter in a non-aqueous solvent in which ethylene carbonate (EC) and ethyl methyl carbonate (EMC) were mixed in a volume ratio of 3:7. A battery X1 of Comparative Example 1 was prepared in the same manner as described in Example 1 above, except for using the just-described non-aqueous electrolyte solution.

### Comparative Example 2

In Comparative Example 2, a lithium-containing transition metal oxide Li_{1.1}Ni_{1/3}Co_{1/3}Mn_{1/3}O₂ was used as the positive electrode active material. This lithium-containing transition metal oxide (Li_{1.1}Ni_{1/3}Co_{1/3}Mn_{1/3}O₂) was analyzed by powder X-ray diffraction analysis for phase identification. The phase identified was a single phase of a structure belonging to the space group R3-m.

A battery X2 of Comparative Example 2 was prepared in the same manner as described in Example 1 above, except for using the lithium-containing transition metal oxide Li_{1.1}Ni_{1/3}Co_{1/3}Mn_{1/3}O₂.

This corresponds to the techniques disclosed in Patent Document 4 and Patent Document 5.

### Comparative Example 3

A non-aqueous electrolyte solution was prepared by dissolving lithium hexafluorophosphate (LiPF₆) at a concentration of 1 mole/liter in a non-aqueous solvent in which ethylene carbonate (EC) and ethyl methyl carbonate (EMC) were mixed in a volume ratio of 3:7. A battery X3 of Comparative Example 3 was prepared in the same manner as described in Comparative Example 2 above, except for using the just-described non-aqueous electrolyte solution.

### Comparative Example 4

In Comparative Example 4, a lithium-containing transition metal oxide LiCoO₂ was used as the positive electrode active material. This lithium-containing transition metal oxide (LiCoO₂) was analyzed by powder X-ray diffraction analysis for phase identification. The phase identified was a single phase of a structure belonging to the space group R3-m.

A battery X4 of Comparative Example 4 was prepared in the same manner as described in Example 1 above, except for using this lithium-containing transition metal oxide LiCoO₂.

This corresponds to the technique disclosed Patent Document 4.

### Comparative Example 5

A non-aqueous electrolyte solution was prepared by dissolving lithium hexafluorophosphate (LiPF₆) at a concentration of 1 mole/liter in a non-aqueous solvent in which ethylene carbonate (EC) and ethyl methyl carbonate (EMC) were mixed in a volume ratio of 3:7. A test battery X5 of Comparative Example 5 was prepared in the same manner as described in Comparative Example 4 above, except for using the just-described non-aqueous electrolyte solution.

### [Evaluation of Discharge Capacity and Cycle Performance]

Each of the batteries of Example 1 and Comparative Examples 1 to 5 was charged at a constant current of 0.2 It until the battery voltage reached 4.8 V and further charged at a constant voltage of 4.8 V until the current value reached 0.05 It. Thereafter, each battery was discharged at a constant current of 0.2 It until the battery voltage reached 2.0 V, to calculate the initial discharge capacity Q1 per unit mass of the positive electrode active material. The results are shown in Table 1 below. In this charge-discharge test, the positive electrode potential just before the end of charge was 4.8 V versus metallic lithium.

Subsequently, for each of the batteries of Example 1 and Comparative Examples 1 to 3, the charge-discharge cycle under the same conditions was repeated 19 times to obtain the discharge capacity Q2 at the 20th cycle. Also, the capacity retention ratio after the charge-discharge cycles, defined as the ratio of the capacity Q2 to the capacity Q1[(Q2/Q1)×100], was obtained for each battery. The results are also shown in Table 1 below.

TABLE 1

| | | | | Capacity |
|---|---|---|---|---|
| | | | Discharge | retention ratio |
| | | Positive electrode/ | capacity Q1 | (Q2/Q1) × 100 |
| | Battery | Electrolyte solution | (mAh/g) | (%) |
| Ex. 1 | A1 | Li_{1.2}Mn_{0.54}Ni_{0.13}Co_{0.13}O₂/ | 245 | 90 |
| | | 1M LiPF₆ FEC/EMC (3/7) | | |
| Comp. Ex. 1 | X1 | Li_{1.2}Mn_{0.54}Ni_{0.13}Co_{0.13}O₂/ | 244 | 62 |
| | | 1M LiPF₆ EC/EMC (3/7) | | |
| Comp. Ex. 2 | X2 | Li_{1.1}Ni_{1/3}Co_{1/3}Mn_{1/3}O₂/ | 198 | 71 |
| | | 1M LiPF₆ FEC/EMC (3/7) | | |
| Comp. Ex. 3 | X3 | Li_{1.1}Ni_{1/3}Co_{1/3}Mn_{1/3}O₂/ | 197 | 60 |
| | | 1M LiPF₆ EC/EMC (3/7) | | |
| Comp. Ex. 4 | X4 | LiCoO₂/ | 222 | 64 |
| | | 1M LiPF₆ FEC/EMC (3/7) | | |
| Comp. Ex. 5 | X5 | LiCoO₂/ | 222 | 54 |
| | | 1M LiPF₆ EC/EMC (3/7) | | |

As clearly seen from Table 1 above, the batteries A1 and X1 exhibited higher discharge capacities than the batteries X2, X3, X4, and X5. The batteries A1 and X1 used, as the positive electrode active material, Li_{1.2}Mn_{0.54}Ni_{0.13}Co_{0.13}O₂, a lithium-containing transition metal oxide that generates oxygen gas during the initial charge. The batteries X2, X3, X4, and X5 used Li_{1.1}Ni_{1/3}Co_{1/3}Mn_{1/3}O₂ or LiCoO₂, a lithium-containing transition metal oxide that does not generate oxygen gas during the initial charge.

Regarding the cycle performance at high voltage, the batteries X2 and X4, which respectively used Li_{1.1}Ni_{1/3}Co_{1/3}Mn_{1/3}O₂ and LiCoO₂, lithium-containing transition metal oxides that do not generate oxygen gas during the initial charge, showed improvements in cycle performance by using a fluorinated cyclic carbonate in which fluorine atoms are directly bonded to a carbonate ring as the non-aqueous solvent, as disclosed in Patent Document 4 and Patent Document 5. However, the improvements were not sufficient.

In contrast, the battery A1 was found to exhibit significantly better high-voltage cycle performance than the comparative batteries X1, X2, X3, X4, and X5. Note that the battery A1 uses the lithium-containing transition metal oxide Li_{1.2}Mn_{0.54}Ni_{0.13}Co_{0.13}O₂, which generates oxygen gas during the initial charge and the fluorinated cyclic carbonate in which fluorine atoms are directly bonded to a carbonate ring.

Although not clearly understood, the reason is believed to be as follows. A stable surface film is formed on the positive electrode active material surface because of the presence of the fluorinated cyclic carbonate in which fluorine atoms are directly bonded to a carbonate ring. Because of the presence of this surface film, it is believed that when oxygen is desorbed from the positive electrode active material during the initial charge, the desorbed oxygen is prevented from forming oxygen radicals, and cycle life deterioration is inhibited; moreover, oxygen is extracted uniformly from the positive electrode active material (Li_{1.2}Mn_{0.54}Ni_{0.13}Co_{0.13}O₂), and as a result, a stable structure was obtained even at a high voltage.

On the other hand, even when using Li_{1.2}Mn_{0.54}Ni_{0.13}Co_{0.13}O₂, a lithium-containing transition metal oxide that generates oxygen gas during initial charge, the battery X1, which does not use a fluorinated cyclic carbonate, showed poor cycle performance. In this case, some of the oxygen atoms desorbed from the positive electrode active material during the initial charge form oxygen radicals. It is believed that because of the presence of the oxygen radicals, side reactions such as the decomposition of the electrolyte solution and dissolving of the transition metals from the positive electrode active material are caused successively during the repeated charge-discharge cycles at high voltage. As a consequence, the cycle life deterioration takes place, and an instable structure at high voltage is formed because oxygen is not uniformly extracted from the positive electrode active material.

Thus, by the combination of a lithium-containing transition metal oxide that generates oxygen gas during initial charge and a fluorinated cyclic carbonate in which fluorine atoms are directly bonded to a carbonate ring, oxygen is desorbed uniformly from the positive electrode active material, and the generation of oxygen radicals is inhibited. As a result, excellent high-voltage cycle performance can be obtained.

### Experiment 2

Next, the cycle performance and charge voltage were studied for the batteries that used a graphite material as the negative electrode active material.

### Examples 2 and 3

### Preparation of Positive Electrode

In Examples 2 and 3, a lithium-excess transition metal oxide Li_{1.2}Mn_{0.54}Ni_{0.13}Co_{0.13}O₂ was used as the positive electrode active material.

First, lithium hydroxide (LiOH) and Mn_{0.67}Ni_{0.17}Co_{0.17}(OH)₂ prepared by coprecipitatation were mixed so as to be in a desired stoichiometric ratio, and the mixed powder was used as the starting material. The mixed powder was formed into pellets and sintered in the air at 900° C. for 24 hours. Thus, a positive electrode active material comprising Li_{1.2}Mn_{0.54}Ni_{0.13}Co_{0.13}O₂ was synthesized.

The resultant lithium-containing transition metal oxide (Li_{1.2}Mn_{0.54}Ni_{0.13}Co_{0.13}O₂) was analyzed by powder X-ray diffraction analysis for phase identification. The phase identified was a mixed phase of a structure belonging to the space group R-3m and a structure belonging to the space group C2/m or C2/c.

Next, using the lithium-containing transition metal oxide as the positive electrode active material, 90 parts by mass of the active material, 5 parts by mass of acetylene black as a conductive agent, and 5 parts by mass of polyvinylidene fluoride as a binder agent were mixed together, and thereafter, N-methyl-2-pyrrolidone was added to the mixture to prepare a slurry. The resultant slurry was applied onto both sides of a current collector made of an aluminum foil and then dried. Thereafter, the resultant material was pressed using pressure rollers and then cut into a predetermined size. Next, a current collector lead made of aluminum was attached to a portion of the electrode on which the slurry was not applied. A positive electrode was thus prepared.

### Preparation of Negative Electrode

Using graphite powder (d₀₀₂=0.336 nm, Lc>100 nm) as the negative electrode active material, 97.5 parts by mass of the negative electrode active material was mixed with 1 part by mass of styrene-butadiene rubber (SBR) and 1.5 parts by mass of carboxymethylcellulose (CMC), and thereafter, water was added to the mixture to prepare a slurry. The resultant slurry was applied onto both sides of a current collector made of a copper foil and then dried. Thereafter, the resultant material was pressed using pressure rollers and then cut into a predetermined size. Next, a current collector lead made of nickel was attached to a portion of the electrode on which the slurry was not applied. A negative electrode was thus prepared.

### Preparation of Non-Aqueous Electrolyte Solution

Lithium hexafluorophosphate (LiPF₆) was dissolved at a concentration of 1 mole/liter in a non-aqueous solvent in which 4-fluoroethylene carbonate (FEC) and ethyl methyl carbonate (EMC) were mixed in a 3:7 volume ratio, whereby a non-aqueous electrolyte was prepared.

### Preparation of Battery

The positive electrode and the negative electrode prepared in the above-described manner were opposed with a polyethylene separator interposed therebetween, and they were placed in a laminate case. The laminate case was filled with the above-described non-aqueous electrolyte solution and then sealed. Thus, non-aqueous electrolyte batteries B1 (Example 2) and B2 (Example 3) were prepared.

### Comparative Examples 6 and 7

A non-aqueous electrolyte solution was prepared by dissolving lithium hexafluorophosphate (LiPF₆) at a concentration of 1 mole/liter in a non-aqueous solvent in which ethylene carbonate (EC) and ethyl methyl carbonate (EMC) were mixed in a volume ratio of 3:7. Comparative batteries Y1 (Comparative Example 6) and Y2 (Comparative Example 7) were prepared in the same manner as described in Example 2 above, except for using the just-described non-aqueous electrolyte solution.

### Comparative Examples 8 and 9

In Comparative Examples 8 and 9, a lithium-containing transition metal oxide Li_{1.1}Ni_{1/3}Co_{1/3}Mn_{1/3}O₂ was used as the positive electrode active material. The lithium-containing transition metal oxide (Li_{1.1}Ni_{1/3}Co_{1/3}Mn_{1/3}O₂) was analyzed by powder X-ray diffraction analysis for phase identification. The phase identified was a single phase of a structure belonging to the space group R3-m.

Comparative batteries Y3 (Comparative Example 8) and Y4 (Comparative Example 9) were prepared in the same manner as described in Example 2 above, except for using the lithium-containing transition metal oxide Li_{1.1}Ni_{1/3}Co_{1/3}Mn_{1/3}O₂.

These correspond to the techniques disclosed in Patent Document 4 and Patent Document 5.

### Comparative Examples 10 and 11

A non-aqueous electrolyte solution was prepared by dissolving lithium hexafluorophosphate (LiPF₆) at a concentration of 1 mole/liter in a non-aqueous solvent in which ethylene carbonate (EC) and ethyl methyl carbonate (EMC) were mixed in a volume ratio of 3:7. Comparative batteries Y5 (Comparative Example 10) and Y6 (Comparative Example 11) were prepared in the same manner as described in Comparative Example 8 above, except for using the just-described non-aqueous electrolyte solution.

### [Evaluation of Discharge Capacity and Cycle Performance]

Each of the batteries of Example 2 and Comparative Examples 6, 8, and 10 was charged at a constant current of 0.2 It until the battery voltage reached 4.5 V and further charged at a constant voltage of 4.5 V until the current value reached 0.05 It. Thereafter, each battery was discharged at a constant current of 0.05 It until the battery voltage reached 2.0 V, to calculate the initial discharge capacity Q3 per unit mass of the positive electrode active material. The results are shown in Table 2 below.

In this charge-discharge test, the positive electrode potential just before the end of charge was 4.63 V versus metallic lithium.

Next, the cycle performance was evaluated for each of the batteries of Example 2 and Comparative Examples 6, 8, and 10 in the following manner. Each of the batteries was charged at a constant current of 0.2 It until the battery voltage reached 4.5 V and further charged at a constant voltage of 4.5 V until the current value reached 0.05 It. Thereafter, each battery was discharged at a constant current of 0.2 It until the battery voltage reached 2.0 V, to calculate the initial discharge capacity Q4 per unit mass of the positive electrode active material. Subsequently, for each battery, the charge-discharge cycle under the same conditions was repeated 19 times to obtain the discharge capacity Q5 at the 20th cycle. Also, the capacity retention ratio after the charge-discharge cycles, defined as the ratio of the capacity Q5 to the capacity Q4[(Q5/Q4)×100], was obtained for each battery. The results are also shown in Table 2 below.

For each of the batteries of Example 3 and Comparative Examples 7, 9, and 11, the upper limit voltage was varied in the test. Each of the batteries was charged at a constant current of 0.2 It until the battery voltage reached 4.7 V and further charged at a constant voltage of 4.7 V until the current value reached 0.05 It. Thereafter, each battery was discharged at a constant current of 0.05 It until the battery voltage reached 2.0 V, to calculate the initial discharge capacity Q6 per unit mass of the positive electrode active material. The results are shown in Table 3 below. In this charge-discharge test, the positive electrode potential just before the end of charge was 4.82 V versus metallic lithium.

Next, the cycle performance was evaluated for each of the batteries of Example 2 and Comparative Examples 7, 9, and 11 in the following manner. Each of the batteries was charged at a constant current of 0.2 It until the battery voltage reached 4.7 V and further charged at a constant voltage of 4.7 V until the current value reached 0.05 It.

Thereafter, each battery was discharged at a constant current of 0.2 It until the battery voltage reached 2.0 V, to calculate the initial discharge capacity Q7 per unit mass of the positive electrode active material. Subsequently, for each battery, the charge-discharge cycle under the same conditions was repeated 19 times to obtain the discharge capacity Q8 at the 20th cycle. Also, the capacity retention ratio after the charge-discharge cycles, defined as the ratio of the capacity Q8 to the capacity Q7[(Q8/Q7)×100], was obtained for each battery. The results are also shown in Table 3 below.

TABLE 2

| | | | | Capacity |
|---|---|---|---|---|
| | | | Discharge | retention ratio |
| | | Positive electrode/ | capacity Q3 | (Q5/Q4) × 100 |
| | Battery | Electrolyte solution | (mAh/g) | (%) |
| Ex. 2 | B1 | Li_{1.2}Mn_{0.54}Ni_{0.13}Co_{0.13}O₂/ | 239 | 95 |
| | | 1M LiPF₆ FEC/EMC (3/7) | | |
| Comp. Ex. 6 | Y1 | Li_{1.2}Mn_{0.54}Ni_{0.13}Co_{0.13}O₂/ | 239 | 53 |
| | | 1M LiPF₆ EC/EMC (3/7) | | |
| Comp. Ex. 8 | Y3 | Li_{1.1}Ni_{1/3}Co_{1/3}Mn_{1/3}O₂/ | 191 | 95 |
| | | 1M LiPF₆ FEC/EMC (3/7) | | |
| Comp. Ex. 10 | Y5 | Li_{1.1}Ni_{1/3}Co_{1/3}Mn_{1/3}O₂/ | 193 | 91 |
| | | 1M LiPF₆ EC/EMC (3/7) | | |

TABLE 3

| | | | | Capacity |
|---|---|---|---|---|
| | | | Discharge | retention ratio |
| | | Positive electrode/ | capacity Q6 | (Q8/Q7) × 100 |
| | Battery | Electrolyte solution | (mAh/g) | (%) |
| Ex. 3 | B2 | Li_{1.2}Mn_{0.54}Ni_{0.13}Co_{0.13}O₂/ | 260 | 90 |
| | | 1M LiPF₆ FEC/EMC (3/7) | | |
| Comp. Ex. 7 | Y2 | Li_{1.2}Mn_{0.54}Ni_{0.13}Co_{0.13}O₂/ | 256 | 49 |
| | | 1M LiPF₆ EC/EMC (3/7) | | |
| Comp. Ex. 9 | Y4 | Li_{1.1}Ni_{1/3}Co_{1/3}Mn_{1/3}O₂/ | 208 | 78 |
| | | 1M LiPF₆ FEC/EMC (3/7) | | |
| Comp. Ex. 11 | Y6 | Li_{1.1}Ni_{1/3}Co_{1/3}Mn_{1/3}O₂/ | 206 | 66 |
| | | 1M LiPF₆ EC/EMC (3/7) | | |

As clearly seen from Tables 2 and 3 above, the batteries using the lithium-containing transition metal oxide that generates oxygen gas during the initial charge (Li_{1.2}Mn_{0.54}Ni_{0.13}Co_{0.13}O₂) as the positive electrode active material exhibited higher discharge capacities than the batteries using the lithium-containing transition metal oxide that does not generate oxygen gas during the initial charge (Li_{1.1}Ni_{1/3}Co_{1/3}Mn_{1/3}O₂).

Regarding the cycle performance with an upper limit voltage of 4.5 V (see Table 2), the use of the fluorinated cyclic carbonate in which fluorine atoms are directly bonded to a carbonate ring as the non-aqueous solvent resulted in an improvement in the cycle performance for the battery using the lithium-containing transition metal oxide that does not generate oxygen gas during the initial charge (Li_{1.1}Ni_{1/3}Co_{1/3}Mn_{1/3}O₂), as disclosed in Patent Document 4 and Patent Document 5. However, even when the fluorinated cyclic carbonate in which fluorine atoms are directly bonded to a carbonate ring was not used, severe capacity degradation was not observed for a small number of cycles such as 20 cycles.

On the other hand, in the case of using the lithium-containing transition metal oxide that generates oxygen gas during initial charge (Li_{1.2}Mn_{0.54}Ni_{0.13}Co_{0.13}O₂), severe capacity degradation was observed at the 20th cycle for the battery Y1, which did not use the fluorinated cyclic carbonate in which fluorine atoms are directly bonded to a carbonate ring. The reason is believed to be as follows. In the case of using Li_{1.2}Mn_{0.54}Ni_{0.13}Co_{0.13}O₂ as the positive electrode active material, some of the oxygen atoms desorbed from the positive electrode active material during the initial charge form oxygen radicals. Because of the presence of the oxygen radicals, side reactions such as the decomposition of the electrolyte solution and dissolving of the transition metals from the positive electrode active material are caused successively during the repeated charge-discharge cycles, and consequently, the cycle deterioration is caused.

In contrast, the battery B1, which uses both the lithium-containing transition metal oxide that generates oxygen gas during initial charge (Li_{1.2}Mn_{0.54}Ni_{0.13}Co_{0.13}O₂) and the fluorinated cyclic carbonate in which fluorine atoms are directly bonded to a carbonate ring, exhibits superior cycle performance to the battery Y1.

Although not clearly understood, the reason is believed to be as follows. A stable surface film is formed on the positive electrode active material surface because of the presence of the fluorinated cyclic carbonate in which fluorine atoms are directly bonded to a carbonate ring. Because of the presence of the surface film, it is believed that the oxygen desorbed from the positive electrode active material during the initial charge is inhibited from forming oxygen radicals, and the cycle degradation was prevented.

Moreover, as clearly seen from Table 3, the battery B2, which uses both Li_{1.2}Mn_{0.54}Ni_{0.13}Co_{0.13}O₂, the lithium-containing transition metal oxide that generates oxygen gas during initial charge, and the fluorinated cyclic carbonate in which fluorine atoms are directly bonded to a carbonate ring, exhibits superior cycle performance to the batteries Y2, Y4, and Y6.

The reason is believed to be that, as has already been described, a stable surface film is formed on the positive electrode active material surface because of the presence of the fluorinated cyclic carbonate in which fluorine atoms are directly bonded to a carbonate ring. Because of the presence of this surface film, it is believed that when oxygen is desorbed from the positive electrode active material during the initial charge, the desorbed oxygen is prevented from forming oxygen radicals, and cycle life deterioration is inhibited; moreover, oxygen is extracted uniformly from the positive electrode active material (Li_{1.2}Mn_{0.54}Ni_{0.13}Co_{0.13}O₂), and as a result, a stable structure was obtained even at a higher voltage.

### Experiment 3

Next, a study was conducted about whether oxygen was released from a positive electrode active material during initial charge.

### Reference Example 1

In Reference Example 1, a lithium-excess transition metal oxide Li_{1.2}Mn_{0.54}Ni_{0.13}Co_{0.13}O₂ was used as the positive electrode active material.

A non-aqueous electrolyte solution was prepared by dissolving lithium hexafluorophosphate (LiPF₆) at a concentration of 1 mole/liter in a non-aqueous solvent in which ethylene carbonate (EC) and diethyl carbonate (DEC) were mixed in a volume ratio of 3:7. A battery T1 was prepared in the same manner as in Example 2 above, except for using the just-described non-aqueous electrolyte solution.

### Reference Example 2

In Reference Example 2, a lithium-containing transition metal oxide Li_{1.1}Ni_{1/3}Co_{1/3}Mn_{1/3}O₂ was used as the positive electrode active material.

A non-aqueous electrolyte solution was prepared by dissolving lithium hexafluorophosphate (LiPF₆) at a concentration of 1 mole/liter in a non-aqueous solvent in which ethylene carbonate (EC) and diethyl carbonate (DEC) were mixed in a volume ratio of 3:7.

A battery T2 was prepared in the same manner as described in Example 2 above, except for using the just-described non-aqueous electrolyte solution and the positive electrode active material comprising the lithium-containing transition metal oxide Li_{1.1}Ni_{1/3}Co_{1/3}Mn_{1/3}O₂.

Each of the batteries of Reference Examples 1 and 2 prepared in the above-described manners was charged at a constant current of 0.2 It until the battery voltage reached 4.5 V and further charged at a constant voltage of 4.5 V until the current value reached 0.05 It. The gas inside each of the batteries that had undergone the initial charge was taken out, and the generated gas was analyzed by gas chromatography (GC) analysis. The results are shown in Table 4 below. Note that the gas composition is shown by volume % in Table 4.

TABLE 4

| | <Reference example 1> | <Reference example 2> |
|---|---|---|
| | Battery T1 | Battery T2 |
| | (Positive electrode: | (Positive electrode: |
| | Li_{1.2}Mn_{0.54}Ni_{0.13}Co_{0.13}O₂) | Li_{1.1}Ni_{1/3}Co_{1/3}Mn_{1/3}O₂) |
| Generated gas | Amount (volume %) | Amount (volume %) |
| H₂ | 3.2 | 24.1 |
| O₂ | 71.7 | — |
| CO | 6.2 | 23.7 |
| CO₂ | 3 | 11.9 |
| CH₄ | — | — |
| C₂H₄ | 15.9 | 40.3 |

As clearly seen from Table 4, it was confirmed that oxygen gas was generated during initial charge in the battery using Li_{1.2}Mn_{0.54}Ni_{0.13}Co_{0.13}O₂, a lithium-excess transition metal oxide comprising a mixed phase of a structure belonging to the space group R3-m and a structure belonging to the space group C2/m, as the positive electrode active material. It is believed that this oxygen gas was generated because, when Li was extracted from the Li₂MnO₃(Li[Li_{1/3}Mn_{2/3}]O₂) portion contained in the lithium-excess transition metal oxide Li_{1.2}Mn_{0.54}Ni_{0.13}Co_{0.13}O₂, oxygen atoms were also released.

On the other hand, oxygen gas was not detected from the battery using Li_{1.1}Ni_{1/3}Co_{1/3}Mn_{1/3}O₂, a lithium-containing transition metal oxide that does not have a structure belonging to the space group C2/m, as the positive electrode active material.

### Experiment 4

Next, an evaluation of discharge rate performance was conducted using test cells.

### Example 4

### Preparation of Positive Electrode

In this example, a positive electrode was prepared in the same manner as described in Example 1 above, using a lithium-containing transition metal oxide Li_{1.2}Mn_{0.54}Ni_{0.13}Co_{0.13}O₂, obtained as in Example 1, as the positive electrode active material.

### Preparation of Negative Electrode

A rolled lithium plate with a predetermined thickness was cut into a predetermined size, and a current collector lead made of nickel was attached thereto. Thus, a negative electrode was prepared.

### Preparation of Non-Aqueous Electrolyte Solution

Lithium hexafluorophosphate (LiPF₆) was dissolved at a concentration of 1 mole/liter in a non-aqueous solvent in which 4-fluoroethylene carbonate (FEC) and diethyl carbonate (DEC) were mixed in a 3:7 volume ratio, whereby a non-aqueous electrolyte solution was prepared.

### Preparation of Three-Electrode Beaker Cell

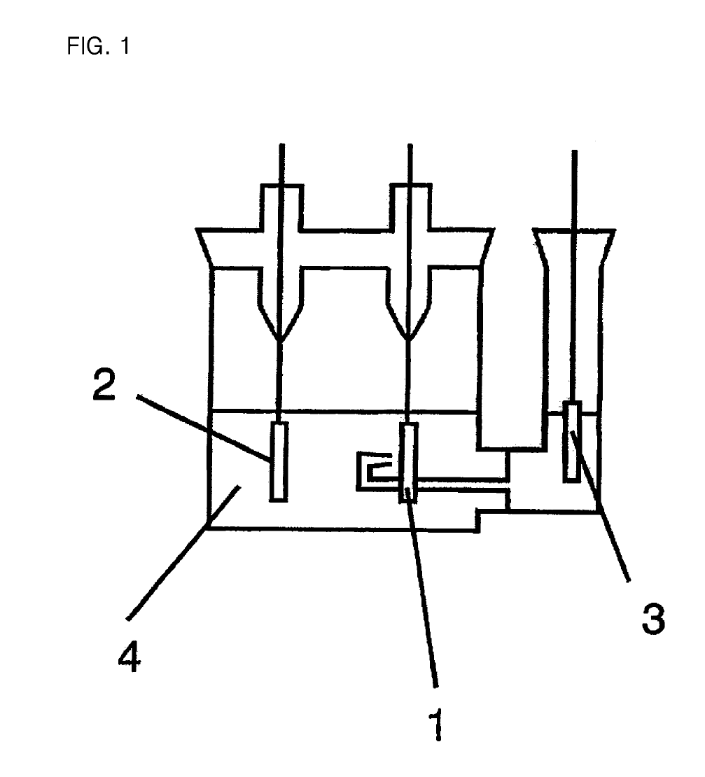

A three-electrode beaker cell C1 as illustrated in FIG. 1 was prepared by using the positive electrode and the negative electrode prepared in the above-described manner as the working electrode and the counter electrode, respectively, and filling the just-described non-aqueous electrolyte solution in a beaker. In a three-electrode beaker cell, a working electrode 1, a counter electrode 2, and a reference electrode 3 are immersed in an electrolyte solution 4, as illustrated in FIG. 1. For the reference electrode, metallic lithium was used.

### Example 5

### Preparation of Positive Electrode

A lithium-containing transition metal oxide Li_{1.2}Mn_{0.54}Ni_{0.13}Co_{0.13}O₂, as obtained in Example 1, was used as the positive electrode active material. A positive electrode was prepared in the same manner as described in Example 4 above, except that, when mixing the positive electrode active material, a conductive agent, and a binder agent, 1 weight % of lithium phosphate (Li₃PO₄) with respect to the positive electrode active material was added to the mixture.

### Preparation of Three-Electrode Beaker Cell

A three-electrode beaker cell D1 was prepared in the same manner as described in Example 4 above, except for using the positive electrode prepared in the just-described manner.

### [Evaluation of Discharge Rate Performance]

Each of the three-electrode beaker cells C1 and D1 was charged at a constant current of 0.2 It until the potential of the working electrode reached 4.8 V (vs. Li/Li') and further charged at a constant voltage of 4.8 V until the current value reached 0.05 It. Thereafter, each cell was discharged at a constant current of 0.05 It until the potential reached 2.0 V (vs. Li/Li⁺), to calculate the initial discharge capacity Q9 (0.05 It capacity) per unit mass of the positive electrode active material at 0.05 It.

Subsequently, each of the cells was charged under the same conditions, and thereafter discharged at a constant current of 2 It until the potential reached 2.0 V (vs. Li/Li⁺), to calculate the initial discharge capacity Q10 (2 It capacity) per unit mass of the positive electrode active material at 2 It.

From the two kinds of capacities, the discharge rate ratio was calculated according to the following equation. The results are shown in Table 5.

Discharge rate ratio (%)=Q10(2 It capacity)/Q9(0.05 It capacity)×100

### [Evaluation of Cycle Performance]

The capacity retention ratio at the 20th cycle {(Q2/Q1)×100} was determined for each cell in the same manner as described in the experiment 1. The results of the measurement are shown in Table 5 below. The capacity retention ratios shown in Table 5 are relative values when taking the capacity retention ratio value of Example 4 as 100.

TABLE 5

| | | | Discharge | Capacity |
|---|---|---|---|---|
| | | | rate ratio | retention ratio |
| | | Positive electrode/ | (Q10/Q9) | (Q2/Q1) |
| | Battery | Electrolyte solution | (%) | (%) |
| Ex. 4 | C1 | Li_{1.2}Mn_{0.54}Ni_{0.13}Co_{0.13}O₂/ | 66.0 | 100 |
| | | 1M LiPF₆ FEC/DEC (3/7) | | |
| Ex. 5 | D1 | Li_{1.2}Mn_{0.54}Ni_{0.13}Co_{0.13}O₂ + | 70.0 | 104 |
| | | 1 wt. % Li₃PO₄/ | | |
| | | 1M LiPF₆ FEC/DEC (3/7) | | |

As clearly seen from the results shown in Table 5, the cell D1, in which Li₃PO₄ was added to the positive electrode, exhibited a higher discharge rate ratio than the cell C1, in which Li₃PO₄ was not added. Although the details are not clear, the reason why the discharge rate performance is improved by adding Li₃PO₄ to the positive electrode is believed to be as follows. A stable surface film is believed to be formed on the positive electrode surface because of the presence of the fluorinated cyclic carbonate, and by adding Li₃PO₄ to the positive electrode, ion diffusion in the surface film is improved. As a result, the discharge rate performance can be improved. In addition, even when Li₃PO₄ was added to the positive electrode, a high capacity retention ratio was obtained, as shown in Table 5, so an advantageous effect of the present invention, excellent cycle performance at high voltage, was obtained.

### Experiment 5

### Example 6

### Preparation of Positive Electrode

In this example, a positive electrode was prepared in the same manner as described in Example 1 above, using a lithium-containing transition metal oxide Li_{1.2}Mn_{0.54}Ni_{0.13}Co_{0.13}O₂, obtained as in Example 1, as the positive electrode active material.

### Preparation of Negative Electrode

A rolled lithium plate with a predetermined thickness was cut into a predetermined size, and a current collector lead made of nickel was attached thereto. Thus, a negative electrode was prepared.

### Preparation of Non-Aqueous Electrolyte Solution

Lithium hexafluorophosphate (LiPF₆) was dissolved at a concentration of 1 mole/liter in a non-aqueous solvent in which 4-fluoroethylene carbonate (FEC) and ethyl methyl carbonate (EMC) were mixed in a 3:7 volume ratio, whereby a non-aqueous electrolyte solution was prepared.

### Preparation of Three-Electrode Beaker Cell

A three-electrode beaker cell E1 as illustrated in FIG. 1 was prepared by using the positive electrode and the negative electrode prepared in the above-described manner as the working electrode and the counter electrode, respectively, and filling the just-described non-aqueous electrolyte solution in a beaker. In a three-electrode beaker cell, a working electrode 1, a counter electrode 2, and a reference electrode 3 are immersed in an electrolyte solution 4, as illustrated in FIG. 1. For the reference electrode, metallic lithium was used.

### Example 7

### Preparation of Positive Electrode

In this example, the positive electrode active material used was a lithium-containing transition metal oxide Li_{1.2}Mn_{0.54}Ni_{0.13}Co_{0.13}O₂ in which Al-containing oxide and/or Al-containing hydroxide having protruding-shape was adhered to or coated on the surface of the positive electrode active material particles in such a manner as to be dispersed uniformly. A method of preparing this positive electrode active material will be described below in detail.

200 g of the lithium-containing transition metal oxide Li_{1.2}Mn_{0.54}Ni_{0.13}Co_{0.13}O₂ obtained as in Example 1 was put into 3 liter of ion exchange water. While stirring this, an aluminum sulfate aqueous solution in which 1.68 g of aluminum sulfate was dissolved in 100 mL of ion exchange water was added thereto, and sodium hydroxide was added as appropriate to adjust the pH of this solution to 9. As a result of this treatment, aluminum hydroxide was adhered to or coated on the surface of the foregoing lithium-containing transition metal oxide Li_{1.2}Mn_{0.54}Ni_{0.13}Co_{0.13}O₂.

Then, the treatment solution was set aside for 30 minutes, the supernatant liquid was discarded, and the solution was then vacuum filtrated to obtain the resultant substance. For heat-treating, the substance was dried at 120° C. for 4 hours, and further sintered at 250° C. for 5 hours in an air atmosphere. Thereby, the aluminum hydroxide adhered to or coated on the surface of the lithium-containing transition metal oxide Li_{1.2}Mn_{0.54}Ni_{0.13}Co_{0.13}O₂ was changed into aluminum oxide (hereafter also referred to as Al₂O₃). This yielded a positive electrode active material in which aluminum oxide was adhered to or coated with the surface of the positive electrode active material particles comprising the lithium-containing transition metal oxide Li_{1.2}Mn_{0.54}Ni_{0.13}Co_{0.13}O₂.

In this positive electrode active material, the amount of the aluminum oxide adhered to or coated on the surface of the positive electrode active material particles comprising the lithium-containing transition metal oxide Li_{1.2}Mn_{0.54}Ni_{0.13}Co_{0.13}O₂ was 0.25 mass % with respect to the amount of the positive electrode active material particles. A three-electrode beaker cell E2 was prepared in the same manner as described in Example 6 above, except for using the just-described positive electrode active material.

### Comparative Example 12

In this Comparative Example, a three-electrode beaker cell Z1 was prepared in the same manner as described in Example 6 above, except that ethylene carbonate (EC) was used in place of 4-fluoroethylene carbonate (FEC) in the non-aqueous electrolyte solution of Example 6 above.

### Comparative Example 13

In this Comparative Example, a three-electrode beaker cell Z2 was prepared in the same manner as described in Example 7 above, except that ethylene carbonate (EC) was used in place of 4-fluoroethylene carbonate (FEC) in the non-aqueous electrolyte solution of Example 7 above.

Each of the test cells of Examples 6 and 7 and Comparative Examples 12 and 13 prepared in the foregoing manners was charged at a constant current of 0.2 It until the potential of the working electrode reached 4.8 V (vs. Li/Li Thereafter, each cell was discharged at a constant current of 0.2 It until the potential reached 2.0 V (vs. Li/Li to calculate the initial discharge capacity Q11 per unit mass of the positive electrode active material.

Subsequently, for each cell, the charge-discharge cycle under the same conditions was repeated 29 times to obtain the discharge capacity Q12 at the 30th cycle. Also, the capacity retention ratio after the charge-discharge cycles, defined as the ratio of the capacity Q12 to the capacity Q11[(Q12/Q11)×100], was obtained for each battery. The results are shown in Table 6 below.

TABLE 6

| | | | Capacity |
|---|---|---|---|
| | | | retention ratio |
| | | Positive electrode/ | (Q12/Q11) × 100 |
| | Battery | Electrolyte solution | (%) |
| Ex. 6 | E1 | Li_{1.2}Mn_{0.54}Ni_{0.13}Co_{0.13}O₂ | 86 |
| | | 1M LiPF₆ FEC/EMC (3/7) | |
| Ex. 7 | E2 | Al₂O₃-coated | 91 |
| | | Li_{1.2}Mn_{0.54}Ni_{0.13}Co_{0.13}O₂/ | |
| | | 1M LiPF₆ FEC/EMC (3/7) | |
| Comp. Ex. 12 | Z1 | Li_{1.2}Mn_{0.54}Ni_{0.13}Co_{0.13}O₂/ | 54 |
| | | 1M LiPF₆ EC/EMC (3/7) | |
| Comp. Ex. 13 | Z2 | Al₂O₃-coated | 55 |
| | | Li_{1.2}Mn_{0.54}Ni_{0.13}Co_{0.13}O₂/ | |
| | | 1M LiPF₆ EC/EMC (3/7) | |

As clearly seen from Table 6, the cells Z1 and Z2, in which the non-aqueous electrolyte solution did not contain the fluorinated cyclic carbonate, showed considerably inferior cycle performance to the cells E1 and E2. In addition, almost no improvement effect on cycle performance was observed from the comparison between the cell Z2, in which Al₂O₃ was coated on the surface of the positive electrode active material particles, and the cell Z1, in which Al₂O₃ was not coated on the surface of the positive electrode active material particles.

On the other hand, in the cases where the fluorinated cyclic carbonate was used for the non-aqueous electrolyte solution, the cell E2, which used Li_{1.2}Mn_{0.54}Ni_{0.13}Co_{0.13}O₂ in which Al₂O₃ was coated on the surface of the positive electrode active material particles, exhibited a higher capacity retention ratio and thus better high-voltage cycle performance than the cell E1, which used the one in which Al₂O₃ was not coated on the surface of the positive electrode active material particles.

Although the details are not clear, the reason is believed to be as follows. In the case using the fluorinated cyclic carbonate, a stable surface film is formed on the positive electrode active material surface, so the oxygen desorbed from the positive electrode active material during initial charge is prevented from forming oxygen radicals, and the cycle life degradation is prevented even when charged at a high voltage.

Moreover, it is believed that the surface film component originating from the fluorinated cyclic carbonate was made more stable by coating the surface of the positive electrode active material particles with Al₂O₃.

Such an effect is believed to be a unique effect resulting from the presence of the fluorinated cyclic carbonate and the coating of the surface of the positive electrode active material particles with Al₂O₃.

As has been described above, the surface film component originating from the fluorinated cyclic carbonate prevents the oxygen desorbed from the positive electrode active material during initial charge from forming oxygen radicals, inhibiting cycle life degradation even under a high voltage charge environment. As a result, it is possible to provide a non-aqueous electrolyte secondary battery that has high capacity and excellent high-voltage cycle performance. Generally, there is a trade-off between high capacity and cycle performance. However, the present invention has a unique advantageous effect that breaks the trade-off relationship.

The foregoing examples use a laminate battery having a carbon material or metallic lithium for the negative electrode, but the invention can be applied to various other types of non-aqueous electrolyte secondary batteries. For example, the same advantageous effects can be obtained with a non-aqueous electrolyte secondary battery that uses, for example, a silicon material for the negative electrode active material. In addition, the shape of the battery is not particularly limited, and the present invention can be applied to non-aqueous electrolyte secondary batteries in various shapes, such as a cylindrical shape, a box shape, or a flat shape.

Although the foregoing examples have described to use Li_{1.2}Mn_{0.54}Ni_{0.13}Co_{0.13}O₂ as the positive electrode active material, it is possible to use other types of the positive electrode active materials comprising a lithium-containing transition metal oxide that releases oxygen during initial charge, such as represented by the compositional formula

xLi[Li_{1/3}Mn_{2/3}]O₂.(1−x)LiNi_{1/3}Co_{1/3}Mn_{1/3}O₂ (where 0<x<1) or

xLi[Li_{1/3}Mn_{2/3}]O₂.(1−x)LiNi_{1/2}Mn_{1/2}O₂ (where 0<x<1).

Although the foregoing examples have described to use aluminum oxide (Al₂O₃), an Al-containing oxide and/or an Al-containing hydroxide that can make the surface film component originating from the fluorinated cyclic carbonate more stable, such as a composite oxide of Al and Ti and a composite oxide of Al and Mg, may be adhered to or coated on the surface of the positive electrode active material particles.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A non-aqueous electrolyte secondary battery comprising: a positive electrode containing a positive electrode active material, a negative electrode, and a non-aqueous electrolyte solution in which an electrolyte is dissolved in a non-aqueous solvent, wherein: the positive electrode active material comprises a lithium-containing transition metal oxide that releases oxygen during initial charge; and the non-aqueous solvent contains a fluorinated cyclic carbonate in which fluorine atoms are directly bonded to a carbonate ring.

2. A non-aqueous electrolyte secondary battery comprising: a positive electrode containing a positive electrode active material, a negative electrode, and a non-aqueous electrolyte solution in which an electrolyte is dissolved in a non-aqueous solvent, wherein: the positive electrode active material comprises a lithium-containing transition metal oxide represented by the general formula xLi[Li_{1/3}Mn_{2/3}]O₂.(1−x)LiMO₂, where 0<x≦1 and M is at least one transition metal element selected from the group consisting of Ni, Co, and Mn; and the non-aqueous solvent contains a fluorinated cyclic carbonate in which fluorine atoms are directly bonded to a carbonate ring.

3. The non-aqueous electrolyte secondary battery according to claim 2, wherein the lithium-containing transition metal oxide releases oxygen during initial charge.

4. The non-aqueous electrolyte secondary battery according to claim 3, the lithium-containing transition metal oxide comprises a lithium-containing transition metal oxide in which a transition metal of transition metal sites is substituted by lithium.

5. The non-aqueous electrolyte secondary battery according to claim 4, wherein the lithium-containing transition metal oxide is represented by the general formula Li₁₊ₐMn_{b}Ni_{c}Co_{d}Oₑ, where 0<a<0.4, 0.4<b<1, 0≦c<0.4, 0≦d<0.4, 1.9<e<2.1, and a+b+c+d=1.

6. The non-aqueous electrolyte secondary battery according to claim 5, wherein the lithium-containing transition metal oxide has a structure belonging to the space group C2/m or C2/c.

7. The non-aqueous electrolyte secondary battery according to claim 6, wherein the lithium-containing transition metal oxide has a mixed phase of a structure belonging to the space group R-3m and a structure belonging to the space group C2/m or C2/c.

8. The non-aqueous electrolyte secondary battery according to claim 3, wherein the fluorinated cyclic carbonate is 4-fluoroethylene carbonate.

9. The non-aqueous electrolyte secondary battery according to claim 3, wherein the potential of the positive electrode is 4.5 V or higher versus metallic lithium in a fully charged state as a battery.

10. The non-aqueous electrolyte secondary battery according to claim 3, wherein the positive electrode contains lithium phosphate.

11. The non-aqueous electrolyte secondary battery according to claim 10, wherein the amount of the lithium phosphate contained in the positive electrode is within the range of from 0.5 mass % to 5 mass % with respect to the amount of the positive electrode active material contained in the positive electrode.

12. The non-aqueous electrolyte secondary battery according to claim 3, wherein an Al-containing oxide and/or an Al-containing hydroxide is adhered to or coated on the surface of the positive electrode active material particles.

13. The non-aqueous electrolyte secondary battery according to claim 12, wherein the amount of the Al-containing oxide and/or the Al-containing hydroxide is from 0.05 mass % to 5 mass % with respect to the total amount of the positive electrode active material.

14. The non-aqueous electrolyte secondary battery according to claim 12, wherein, when the adhered substance or the coated substance on the surface of the positive electrode active material particles, the Al-containing oxide has protruding-shape.

15. The non-aqueous electrolyte secondary battery according to claim 14, wherein the Al-containing oxide having protruding-shape is an aluminum oxide.

16. The non-aqueous electrolyte secondary battery according to claim 12, wherein the Al-containing oxide and/or the Al-containing hydroxide is adhered to or coated on the surface of the positive electrode active material particles in such a manner as to be dispersed uniformly.

17. The non-aqueous electrolyte secondary battery according to claim 13, wherein the Al-containing oxide and/or the Al-containing hydroxide is adhered to or coated on the surface of the positive electrode active material particles in such a manner as to be dispersed uniformly.

18. The non-aqueous electrolyte secondary battery according to claim 14, wherein the Al-containing oxide and/or the Al-containing hydroxide is adhered to or coated on the surface of the positive electrode active material particles in such a manner as to be dispersed uniformly.

19. The non-aqueous electrolyte secondary battery according to claim 15, wherein the Al-containing oxide and/or the Al-containing hydroxide is adhered to or coated on the surface of the positive electrode active material particles in such a manner as to be dispersed uniformly.
